(19) United States
(12) Patent Application Publication
(10) Pub. No.: US 2013/0273472 A1
(43) Pub. Date: Oct. 17, 2013

(54) METHOD FOR MANUFACTURING TONER

(71) Applicants: Jae Bum Park, Daejeon (KR); Young Jae Kwon, Daejeon (KR); Dae Woong Choi, Daejeon (KR); Dong Woo Kim, Daejeon (KR)

(72) Inventors: Jae Bum Park, Daejeon (KR); Young Jae Kwon, Daejeon (KR); Dae Woong Choi, Daejeon (KR); Dong Woo Kim, Daejeon (KR)

(73) Assignee: SAMSUNG FINE CHEMICALS CO., LTD., Ulsan (KR)

(21) Appl. No.: 13/996,919

(22) PCT Filed: Dec. 21, 2011
(86) PCT No.: PCT/KR2011/009945

§ 371 Date: Jun. 21, 2013

(30) Foreign Application Priority Data
Dec. 24, 2010 (KR) 10-2010-0134753

(51) Int. Cl. G03G 9/08

(52) U.S. Cl. CPC G03G 9/0804
USPC 430/137.14

(57) ABSTRACT

Provided is a method for manufacturing a toner. By using a wax dispersion liquid containing silica, the toner which does not have an unpleasant odor can be achieved without influencing other physical properties of the toner.

### TECHNICAL FIELD

The present invention relates to a method for manufacturing a toner, and more particularly, to a method for manufacturing a toner having no unpleasant odor when used.

### BACKGROUND ART

In general, a toner is prepared by adding a colorant, a wax, or the like to a thermoplastic resin acting as a binder resin. Also, fine inorganic metal powder, such as silica or titanium oxide, may be added as an external additive to a toner in order to provide fluidity to the toner or improve physical properties such as charge controlling or washing of toner. A method of preparing such a toner is classified into a physical method such as a pulverization, or the like, and a chemical method such as a suspension polymerization method, an emulsion aggregation method, or the like.

Meanwhile, a toner may provide unpleasantness due to irritating odor when the toner is used and a toner container (cartridge) is opened, according to toner components itself, impurities generated during a process of preparing the toner, or a trace amount of an aromatic substance such as a material generated by decomposition of a portion of the toner components due to storage of the toner components in environments after the preparation of the toner. In particular, since printed images formed with a toner are heated in a process such as a thermal fixation method when the toner is fixed on a printing medium such as paper, a trace amount of an aromatic substance contained in the toner is released into the atmosphere, and thus, a user feels unpleasant. In order to improve the foregoing limitations, there may be a case in which a filter for adsorbing ozone, odor, or the like is installed in a main body of an apparatus. However, this may be unfavorable in terms of manufacturing costs and may be inconvenient due to the periodical exchange of the filter.

Also, there have been attempts to deodorize toners after their manufacture. However, deodorization effects have been insignificant.

In Japanese Patent Application Laid-Open Publication No. 2002-131980, a method of deodorization by adding cyclic ketone/lactone during polymerization of a latex is disclosed. However, the method may also affect the formation of the latex.

Japanese Patent Application Laid-Open Publication No. 2006-220831 discloses a method of obtaining a deodorization effect by adding deodorizing components, such as iron ions, during aggregation or fusing in a method of preparing a toner by emulsion aggregation. However, since a deodorant may not be uniformly distributed on toner particles, the deodorization effect may be insignificant.

### DETAILED DESCRIPTION OF THE INVENTION

### Technical Problem

The present invention provides a method for manufacturing a toner having no unpleasant odor when the toner is used, by adding a deodorant that does not affect other physical properties of the toner.

### Technical Solution

According to an aspect of the present invention, there is provided a method of preparing a toner including:

preparing a polyester resin dispersion by adding a polyester resin and an organic solvent to a polar solvent containing a surfactant and a dispersion stabilizer under stirring, and then heating;

mixing a colorant dispersion and a wax dispersion with the polyester resin dispersion;

homogenizing the mixed solution by adding a agglomerating agent ;

aggregating the homogenized mixture; and

fusing the aggregated toner particles, wherein the wax dispersion is prepared by dispersing a wax and silica in a dispersion medium.

According to an embodiment of the present invention, the wax dispersion may include silica in an amount ranging from about 0.5 wt % to about 2.0 wt %.

According to another embodiment of the present invention, an average particle size of the silica may be in a range of about 5 nm to about 50 nm.

Hereinafter, the present invention will be described in more detail.

A method of preparing a toner according to an embodiment of the present invention includes: preparing a polyester resin dispersion by adding a polyester resin and an organic solvent to a polar solvent containing a surfactant and a dispersion stabilizer under stirring, and then heating;

mixing a colorant dispersion and a wax dispersion with the polyester resin dispersion;

homogenizing the mixed solution by adding a agglomerating agent;

aggregating the homogenized mixture; and

fusing the aggregated toner particles, wherein the wax dispersion is prepared by dispersing a wax and silica in a dispersion medium.

A typical method of deodorizing a toner may include a method of adding a deodorant during preparation of a latex or adding a deodorant during an aggregation or fusing process. However, in the case that the deodorant is added during the preparation of a latex, there may be difficulties in the preparation of the latex because the added deodorant acts as a nucleating agent, and in the case that the deodorant is added during the aggregation or fusing process, the deodorant may not be uniformly distributed on toner particles. Therefore, in order to address the foregoing limitations in the present invention, silica not affecting charge characteristics of the toner particles is used as a deodorant, and the silica is added during the preparation of a wax dispersion to act as a nucleus during the preparation of a resin dispersion. Thus, the toner may be deodorized without affecting physical properties of the resin or disturbing stability of a pigment dispersion.

In particular, in a method of preparing a toner by polymerization, an amount of total volatile organic compounds (TVOC) may be an issue, and there is an urgent need to reduce the amount of the TVOC in the current atmosphere in which environmentally friendly products are preferred. According to the preparation method of an embodiment of the present invention, the amount of the TVOC may be significantly reduced due to the effective action of the deodorant during thermal fixation of the toner.

In order to describe the method of preparing a toner according to an aspect of the present invention in more detail, the method will be described below by being broadly divided into (A) dispersion preparation process, (B) aggregation process, (C) freezing and fusing process, and (D) washing and drying process.

(A) Dispersion Preparation Process

The dispersion preparation process may be categorized into three types. That is, the dispersion preparation process includes preparation of a polyester resin dispersion, preparation of a colorant dispersion, and preparation of a wax dispersion.

A polyester resin and an organic solvent are added to a polar solvent containing a surfactant and a dispersion stabilizer under stirring to obtain a mixture, and the mixture is then heated to prepare a polyester resin dispersion having a residual organic solvent content of less than 10,000 ppm.

Since the polyester resin dispersion is prepared in a single reactor, a process becomes simple and the time required for processing may be reduced. In addition, since neutralization of the dispersion due to the dispersion stabilizer may uniformly occur, a size of particles in the dispersion may be uniformized.

Also, differing from a typical process in which a polyester resin is completely dissolved in an organic solvent and a polyester resin dispersion is then prepared by mixing with other components, since the polyester resin is sequentially added in the above sequence, the organic solvent may be easily removed during the preparation of the dispersion.

The polar solvent containing a surfactant and a dispersion stabilizer may be prepared by sequentially or simultaneously introducing the surfactant and the dispersion stabilizer into a polar solvent.

A surfactant, a dispersion stabilizer, a polyester resin, and an organic solvent may be sequentially added to the polar solvent in the above sequence.

The heating during the preparation of the polyester resin dispersion may be performed at a temperature above a boiling point of the organic solvent. The heating may be performed for about 3 hours to about 15 hours.

A -size of particles in the polyester resin dispersion may be in a range of about 50 nm to about 300 nm.

The polar solvent may be water, methanol, ethanol, butanol, acetonitrile, acetone, or ethyl acetate, and for example, water may be used. An amount of the polar solvent may be in a range of about 150 parts by weight to about 500 parts by weight based on 100 parts by weight of the polyester resin.

A weight-average molecular weight of the polyester resin used in an embodiment of the present invention may be in a range of about 5,000 to about 50,000, and in the case that the weight-average molecular weight of the polyester resin is less than 5,000, it may adversely affect preservability and fixability of the toner. In the case that the weight-average molecular weight of the polyester resin is greater than about 50,000, it may adversely affect the fixability thereof.

Also, a polydisperse index (PDI) of the polyester resin may be in a range of about 2 to about 10, and a peak molecular weight (Mp) measured by gel permeation chromatography (GPC) may be in a range of about 1,000 to about 10,000. In an embodiment of the present invention, the term “peak molecular weight (Mp)” in GPC denotes a molecular weight calculated from a peak value of an elution curve obtained by a GPC measurement. GPC measurement conditions are as below.

Apparatus: Toyo Soda Manufacturing Co., Ltd., HLC8020

Column: Toyo Soda Manufacturing Co., Ltd., TSKgeIGMHXL (column size: 7.8 mm (ID)×30.0 cm (L)), three columns linked in series

Oven temperature: 40° C.

Eluent: tetrahydrofuran (THF)

The peak molecular weight was determined by drawing a calibration curve using standard polystyrene from the retention time corresponding to a peak value of an obtained elution curve.

The standard polystyrene samples used for drawing the calibration curve were TSK standard, A-500 (molecular weight: 5.0×10²), A-2500 (molecular weight: 2.74×10³), F-2 (molecular weight: 1.96×10⁴), F-20 (molecular weight: 1.9×10⁵), F-40 (molecular weight: 3.55×10⁵), F-80 (molecular weight: 7.06×10⁵), F-128 (molecular weight: 1.09×10⁶), F-288 (molecular weight: 2.89×10⁶), F-700 (molecular weight: 6.77×10⁶) and F-2000 (molecular weight: 2.0×10⁷), by Toyo Soda Manufacturing Co., Ltd.

Also, the term “peak value” of the elution curve denotes a point where the elution curve is at maximum height, and in the case that there are two or more maximum points, the peak value is the maximum value of the elution curve. The eluent is not particularly limited, and any solvent that dissolves the polyester resin, such as chloroform, may be used in addition to THF.

Furthermore, a glass transition temperature of the polyester resin may be in a range of about 40° C. to about 80° C., and for example, may be in a range of about 50° C. to about 75° C. In the case that the glass transition temperature is less than about 40° C., a toner formed by using polyester resin particles may have limitations in preservation stability. In contrast, in the case that the glass transition temperature is greater than about 80° C., offset may be facilitated, and in particular, offset may be more facilitated during color printing.

The polyester resin may not include a sulfonic acid group.

The polyester resin may be prepared by polycondensation of an acid component and an alcohol component. Polyvalent carboxylic acid is mainly used as the acid component, and polyhydric alcohols are mainly used as the alcohol component to prepare the polyester resin.

Examples of the polyhydric alcohol component may be polyoxyethylene-(2,0)-2,2-bis(4-hydroxyphenyl)propane, polyoxypropylene-(2,0)-2,2-bis(4-hydroxyphenyl)propane, polyoxypropylene-(2,2)-polyoxyethylene-(2,0)-2,2-bis(4-hydroxyphenyl)propane, polyoxyethylene-(2,3)-2,2-bis(4-hydroxyphenyl)propane, polyoxypropylene (6) -2,2-bis(4-hydroxyphenyl)propane, polyoxypropylene-(2,3)-2,2-bis(4-hydroxyphenyl) propane, polyoxypropylene-(2,4)-2,2-bis(4-hydroxyphenyl)propane, polyoxypropylene-(3,3)-2,2-bis(4-hydroxyphenyl)propane, polyoxyethylene-(6)-2,2-bis(4-hydroxyphenyl) propane, ethylene glycol, 1,3-propylene glycol, 1,2-propylene glycol, 1,4-butylene glycol, 1,3-butylene glycol, glycerol, and polyoxypropylene. Specifically, the polyvalent carboxylic acid component includes aromatic polyvalent acid and/or an alkyl ester thereof, which are typically used in the preparation of a polyester resin. The aromatic polyvalent acid may be terephthalic acid, isophthalic acid, trimellitic acid, pyromellitic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,2,7,8-octanetetracarboxylic acid, and/or an alkyl ester of these carboxylic acids, and at this time, the alkyl group may be methyl, ethyl, propyl, butyl, or the like. The aromatic polyvalent acid and/or the alkyl ester thereof may be used alone or in combination of two or more.

An acid value of the polyester resin may be in a range of about 5 to about 50, and for example, may be in a range of about 10 to about 20.

Examples of the organic solvent used in the polyester resin dispersion may be at least one selected from the group consisting of dimethyl ether, diethyl ether, 1,1-dichloroethane, 1,2-dichloroethane, dichloromethane, and chloroform. However, the organic solvent is not limited thereto. An amount of the organic solvent may be in a range of about 15 parts by weight to about 200 parts by weight based on 100 parts by weight of the polyester resin.

The surfactant used in the polyester resin dispersion may be an anionic surfactant, and an amount of the surfactant may be in a range of about 1 part by weight to about 4 parts by weight based on 100 parts by weight of the polyester resin.

A monovalent cation-containing base may be used as the dispersion stabilizer used in the polyester resin dispersion. At least one of potassium hydroxide, sodium hydroxide, sodium carbonate, sodium bicarbonate, lithium hydroxide, potassium carbonate, ammonia, triethylamine, triethanolamine, pyridine, ammonium hydroxide, diphenylamine and a derivative thereof, and polyethyleneamine and a derivative thereof may be used as the dispersion stabilizer. For example, sodium hydroxide or potassium hydroxide may be used.

An amount of the dispersion stabilizer used is related to the acid value of the polyester resin. The amount of the dispersion stabilizer may be increased as the acid value is increased, and thus a dispersion having a narrow particle size distribution may be prepared. The amount of the dispersion stabilizer may be in a range of about 2 equivalent weights to about 3 equivalent weights based on the acid value of the polyester resin.

The colorant dispersion may be prepared by dispersing a colorant in water using a dispersant such as a surfactant. In the case of dispersing the colorant in water, an anionic surfactant and a nonionic surfactant may be used as the dispersant, and for example, the anionic surfactant may be used. Since dispersion of a pigment in water may be facilitated by using the dispersant and a particle size of the dispersed pigment in the toner may be decreased, a toner having excellent characteristics may be prepared. The unnecessary dispersant may be removed by a subsequent washing process.

The colorant used may be appropriately selected from commercially available pigments, such as a black pigment, a cyan pigment, a magenta pigment, a yellow pigment, and a mixture thereof.

An amount of the colorant may be set to be such an amount that the toner is sufficiently colored and forms a visible image by development. For example, the amount of the colorant may be in a range of about 3 parts by weight to about 15 parts by weight based on 100 parts by weight of the polyester resin. In the case that the content thereof is less than about 3 parts by weight, coloring effect may be insufficient. In the case that the content thereof is greater than about 15 parts by weight, a sufficient friction charge quantity may not be obtained due to a decrease in electrical resistance of the toner and thus, contamination may occur.

The wax dispersion may be prepared by adding a wax and silica to a dispersion medium and dispersing the wax and the silica.

The dispersion medium may include at least one of water and a water-soluble organic solvent. Purified water may be used as the water. A relative permittivity of the water-soluble organic solvent may be about 5 or more and for example, may be about 10 or more. In the case that the relative permittivity of the water-soluble organic solvent is less than about 5, a relative permittivity of the wax dispersion is also decreased, and thus, electrostatic repulsive forces between wax particles may be decreased and dispersion stability may be reduced. Examples of the water-soluble organic solvent satisfying the above relative permittivity range may be organic solvents such as ethers, alcohols, ether alcohols, esters, ketones, acids, amines, and acid amines. More particularly, the water-soluble organic solvent may include diethylene glycol monobutyl ether, triethylene glycol monobutyl ether, propylene glycol monobutyl ether, ethylene glycol, diethylene glycol, propylene glycol, dimethyl sulfoxide, ethylene carbonate, propylene carbonate, or the like.

A wax included in the wax dispersion may include at least one of a paraffin-based wax and a polyester wax. Since the paraffin-based wax includes straight-chain saturated hydrocarbon having 20 to 36 carbon atoms as a main body, the paraffin-based wax has a weight-average molecular weight ranging from about 30 to about 500 and a melting point ranging from about 40° C. to about 80° C. In the case that the paraffin-based wax is added to the toner, excellent release properties may be obtained. However, since penetration is high, a surface of a fixing roller may be contaminated. Herein, the term “penetration” is a measure of representing consistency or hardness of a material. In order to address the foregoing limitations, a polyester wax, a type of a synthetic wax, may also be added to the toner.

A mixed wax of the paraffin-based wax and the polyester wax, for example, HNP-9 and HNP-11 waxes, may be used. An amount of the wax used may be in a range of about 10 wt % to about 40 wt % of the wax dispersion, and for example, may be in a range of about 25 wt % to about 35 wt %. When the amount of the wax used is within the above range, dispersion stability may be excellent and the wax may sufficiently act as a release agent.

The wax dispersion may further include a surfactant. At least one selected from the group consisting of a nonionic surfactant, an anionic surfactant, a cationic surfactant, and an amphoteric surfactant may be used as the surfactant.

Examples of the nonionic surfactant may be polyvinyl alcohol, polyacrylic acid, polyoxyethylene cetyl ether, polyoxyethylene lauryl ether, polyoxyethylene octylphenyl ether, polyoxyethylene stearyl ether, polyoxyethylene norylphenyl ether, ethoxylate, phosphate norylphenols, triton, and dialkylphenoxypoly(ethyleneoxy)ethanol. Examples of the anionic surfactant may be sodium dodecyl sulfate, sodium dodecyl benezene sulfonate, sodium dodecyl naphthalene sulfate, dialkyl benzenealkyl sulfate, and sulfonate salt. Examples of the cationic surfactant may be alkyl benzene dimethyl ammonium chloride, alkyl trimethyl ammonium chloride, and distearyl ammonium chloride. Examples of the amphoteric surfactant may be amino acid amphoteric surfactant, betaine-based amphoteric surfactant, lecitin, and taurin. The foregoing surfactants may be used alone or in combination of two or more.

The wax dispersion may include silica in an amount ranging from about 0.5 wt % to about 2 wt %.

In the case that the amount of the silica is within the above range, deodorization effect may be obtained without affecting physical properties of the toner such as charge quantity or charge speed.

The silica is not particularly limited so long as it may perform deodorization. In general, an average particle size of the silica may be in a range of about 5 nm to about 50 nm.

Commercially available silica may be used, and for example, RY300 by Nippon Aerosil Co., Ltd. may be used.

The dispersion may be performed in a state in which reactants are heated above the melting point of the wax.

At this time, examples of a dispersing device for the dispersion may be a high-speed rotation mill, a classifier built-in type high-speed rotation mill, a ball mill, a medium agitation type mill, a consolidation shearing mill, a colloid mill, and a roll mill. Also, in this case, steel beads formed of stainless steel and steel or ceramic beads formed of alumina, enstatite, zirconium oxide, zircon, silica, silicon carbide, and silicon nitride may be used as milling media according to a material of a mill. Furthermore, a wax dispersion having nano-sized particles may be obtained by using a Ultimaizer system (Amstec., Model HJP-25030).

(B) Aggregation Process

Each dispersion prepared in the dispersion preparation process is mixed, and a agglomerating agent and acid are then added while stirring to homogenize the dispersion and then aggregate toner particles. The aggregation process may be performed at room temperature, but heating may be performed to near the glass transition temperature (Tg) of the polyester resin. Agglomerates having particles with uniform size and shape may be formed by stirring the mixed solution of each dispersion by mechanical shear force through use of a stirrer.

A known agglomerating agent may be used as the agglomerating agent, and for example, an organic material containing ions having polarity opposite to that of an electrolyte or a pigment may be used. Also, sodium chloride (NaCl), which may be easily washed with pure water and has high solubility with respect to water, may be used. An amount of the agglomerating agent used is in a range of about 0.3 wt % to about 6 wt %, and may be in a range of about 1.0 wt % to about 5 wt %, based on a total solid content. In the case that the amount of the agglomerating agent used is less than about 0.3 wt %, aggregation may not easily occur, and in the case that the amount of the agglomerating agent used is greater than about 6 wt %, a size of aggregated particles may be significantly increased.

The amount of the agglomerating agent used is in a range of about 0.3 wt % to about 6 wt % based on the total solid content of raw materials introduced during the aggregation. However, since the dispersion stabilizer used during the preparation of the polyester resin dispersion may play a secondary role as the agglomerating agent, the dispersion stabilizer may be added in the aggregation.

A pH of the mixed solution may be adjusted by adding an acid in the aggregation process and for example, the pH thereof may be in a range of about 4.5 to about 6.5.

The aggregation process may be performed at a temperature ranging from about 40° C. to about 60° C. by stirring the reaction solution at a speed ranging from about 1.0 m/sec to about 7.0 m/sec.

(C) Freezing and Fusing Process

In order to performing a freezing process, a pH of the reaction solution is increased to 10 while the temperature of the reaction solution is maintained.

At this time, an inorganic base, such as NaOH, KOH, or LiOH, is added in order to increase the pH.

Thereafter, the mixed solution containing toner particles is heated to homogenize the particle size and shape of the aggregated toner particles. The mixed solution is heated to a temperature above the Tg of the polyester resin to control a toner particle size to be in a range of about 1 μm to about 20 μm, and as a result, toner particles having nearly uniform particle size and shape may be obtained.

Surface properties of the toner particles may be improved by heating to a temperature above the Tg of the polyester resin. Before the heating to a temperature above the Tg of the polyester resin, a polyester resin dispersion or a polystyrene butyl acrylate latex may be added to surround the toner particles generated in the aggregation process and thus, leaking of the pigment or the wax to the outside of the particles may be prevented and the toner may be hardened. At this time, a resin dispersion having the same physical properties (Tg, molecular weight) as those of the polyester resin dispersion used in the previous process may be used as the additionally added polyester resin dispersion or polystyrene butyl acrylate latex, and a resin dispersion having higher Tg and molecular weight may be used. In the case that the resin dispersion having higher Tg and molecular weight is used, the Tg may be in a range of about 60° C. to about 85° C. and the molecular weight may be in a range of about 10,000 to about 300,000. A particle size may be increased while surrounding the toner particles generated in the aggregation process with the additionally added resin dispersion, and in order to prevent this, a fusing process may be performed by adding a surfactant or adjusting the pH, and heating the mixed solution to a temperature above the glass transition temperature of the polyester resin.

(D) Washing and Drying Process

This is a process of washing the toner particles obtained in the fusing process with water and drying the toner particles. In the process, the mixed solution containing a toner is cooled to a room temperature, the mixed solution is filtered, a filtrate is removed, and the toner is cleaned with water. Pure water having a conductivity of about 10 μS/cm or less may be used for the washing, and the toner may be cleaned before conductivity of the filtrate used for washing the toner becomes about 50 μS/cm or less. The washing of the toner using pure water may be performed by using a batch-type or continuous-type method. The washing of the toner using pure water is performed to remove unnecessary components other than toner components, such as impurities that may affect chargeability of the toner and an unnecessary agglomerating agent that does not involve in the aggregation.

In the case that the inorganic salt of monovalent metal is used as the agglomerating agent, since reagglomeration of the toner particles may not occur due to the reactivation of the inorganic salt according to the changes in the pH during the washing process, and the solubility of the inorganic salt of monovalent metal with respect to water is relatively high in comparison to that of an inorganic salt of multivalent metal, the removal of the inorganic salt during the washing may be facilitated. As a result, an amount of the inorganic salt remaining in the inside of the toner may be significantly decreased. Therefore, melt viscosity of the toner particles may not be increased and better fixing properties may be obtained.

The toner obtained after the washing process is dried by using a fluidized bed dryer, a flash jet dryer, or the like. Also, external additives may be added to the toner obtained by drying.

### Advantageous Effects

A toner prepared according to a method of the present invention has no unpleasant odor when used.

### Best Mode

Hereinafter, the present invention will be described in more detail, according to the following examples. However, the present invention is not limited thereto.

### PREPARATION EXAMPLE 1

### Synthesis of Polyester Resin

A 3 L reactor equipped with a stirrer, a nitrogen gas inlet, a thermometer, and a cooler was installed in an oil bath, a heating medium. 45 g of terephthalic acid, 39 g of isophthalic acid, 75 g of 1,2-propylene glycol, and 3 g of trimellitic acid were added, and dibutyltin oxide as a catalyst was added in an amount of 500 ppm based on a total weight of a monomer. A temperature of the reactor was increased to 150° C. while stirring was performed at 150 rpm. A reaction was performed for 6 hours and the temperature was increased to 220° C., the reactor was depressurized to 0.1 torr for removing byproducts, and the reaction was performed for 15 hours under the same pressure condition to obtain a polyester resin.

Glass Transition Temperature (Tg, ° C.) Measurement

A sample was heated from about 20° C. to about 200° C. at a heating rate of 10° C./minute by using a differential scanning calorimeter (Netzsch Group) and then rapidly cooled to 10° C. at a cooling rate of 20° C./minute. Thereafter, a glass transition temperature of the sample was measured by again increasing the temperature at a heating rate of 10° C./minute.

Acid Value Measurement

The resin was dissolved in dichloromethane and cooled, and an acid value (mg KOH/g) was then measured by titrating with a 0.1 N KOH methyl alcohol solution.

Weight-Average Molecular Weight and Mp Measurements

A weight-average molecular weight of the binder resin was measured by gel permeation chromatography (GPC) using a calibration curve obtained using a polystyrene standard sample.

A peak molecular weight (Mp) was determined by standard polystyrene conversion from the retention time corresponding to a peak value of an elution curve obtained by GPC. Also, the term “peak value” of the elution curve denotes a point where the elution curve is at maximum height, and in the case that there are two or more maximum points, the peak value is the maximum value of the elution curve. Furthermore, the terms “signal intensity I (Mp) of a GPC curve at a position of the peak molecular weight” and “signal intensity I (M100000) of the GPC curve at a position of a molecular weight of 100,000” respectively denote a difference between the signal intensity at the position of the peak molecular weight and the signal intensity at baseline, and a difference between the signal intensity at the position of a molecular weight of 100,000 and the signal intensity at baseline. These signal intensities are represented as potential (mV).

Apparatus: Toyo Soda Manufacturing Co., Ltd., HLC8020

Column: Toyo Soda Manufacturing Co., Ltd., TSKgeIGMHXL (column size: 7.8 mm(ID)×30.0 cm (L)), three columns linked in series

Oven temperature: 40° C.

Eluent: THF

Sample concentration: 4 mg/10 ml

Filtering condition: sample solution was filtered with a 0.45 μm Teflon (trademark) membrane filter

Flow rate: 1 ml/minute

Injection volume: 0.1 ml

Detector: RI

Standard polystyrene samples for drawing a calibration curve: Toyo Soda Manufacturing Co., Ltd, TSK standard, A-500 (molecular weight: 5.0×10²), A-2500 (molecular weight: 2.74×10³), F-2 (molecular weight: 1.96×10⁴), F-20 (molecular weight: 1.9×10⁵), F-40 (molecular weight: 3.55×10⁵), F-80 (molecular weight: 7.06×10⁵), F-128 (molecular weight: 1.09×10⁶), F-288 (molecular weight: 2.89×10⁶), F-700 (molecular weight: 6.77×10⁶) and F-2000 (molecular weight: 2.0×10⁷).

The obtained polyester resin had a glass transition temperature (Tg) of 66° C., an acid value of 11 mg KOH/g, a weigh-average molecular weight of 18,000, an Mp of 5100, and a T_{1/2} of 125° C.

### PREPARATION EXAMPLE 2

### Preparation of Polyester Resin Dispersion

46 g of a 4 wt % sodium hydroxide solution (2.5 the equivalent weights based on the acid value of the polyester resin) as a dispersion stabilizer was introduced into a 3 L reactor equipped with a thermometer and an impeller-type stirrer, and 6.67 g of a surfactant (dowfax, Dow Corning Corporation, 1 wt % with respect to the amount of the polyester resin) and 958 g of water were added thereto. 300 g of the polyester resin in a solid phase and 500 g of methyl ethyl ketone were introduced thereinto, and refluxing was performed at 70° C. for 1 hour. Then, the organic solvent was removed while nitrogen was purged at 80° C. for 4 hours. Finally, a polyester resin dispersion was obtained.

### PREPARATION EXAMPLE 3

### Preparation of Pigment Dispersion

3 kg of a cyan pigment (Dainichiseika Color & Chemicals Mfg. Co., Ltd., ECB-303) was introduced into a 20 L reactor, 11.5 kg of purified water and 0.6 kg of hydroxypropylmethyl cellulose acetate phthalate (Samsung Fine Chemicals Co. Ltd., AnyCoat-P) were further added to the reactor, and stirring was performed at a speed of 50 rpm. Subsequently, a content in the reactor was transferred to a ball mill type reactor to perform preliminary dispersion. As a result of the preliminary dispersion, dispersed cyan pigment particles having a volume-average particle diameter (D50(v)) of 3.4 μm (measured using a Coulter Multisizer by Beckman Coulter, Inc.) were obtained. Thereafter, high dispersion of the content in the reactor was performed at a pressure of 1,500 bar by using an Ultimaizer system (Amstec Ltd., Model HJP25030). As a result of the high dispersion, dispersed nanosized cyan pigment particles having a D50(v) of 150 nm (measured by using a Microtrac 252 by Microtrac, Inc.) were obtained.

### PREPARATION EXAMPLE 4

### Preparation of Wax Dispersion (1)

65 g of alkyldiphenyloxide disulfonate (45% Dowfax 2A1) as an anionic surfactant, 1.935 kg of distilled water, 1,000 g of a wax (NOF corporation, Japan, WE-5), and 0.5 wt % (based on the wax dispersion) of silica having an average particle size of 7 nm were introduced into a 5 L reactor equipped with a stirrer, a thermometer, and a condenser. The mixture was dispersed for 30 minutes by using a homogenizer (IKA). As a result, a wax dispersion was obtained. After the completion of the dispersion, as a result of measuring a particle size of the dispersed particles by using a Mastersizer 2000 (Malvern Instruments Ltd.), D50(v) was 320 nm.

### PREPARATION EXAMPLE 5

### Preparation of Wax Dispersion (2)

A wax dispersion (2) was prepared in the same manner as Preparation Example 4, except that 2.0 wt % of silica was added.

### PREPARATION EXAMPLE 6

### Preparation of Wax Dispersion (3)

A wax dispersion (3) was prepared in the same manner as Preparation Example 4, except that 2.5 wt % of silica was added.

### EXAMPLE 1

A mixed solution was obtained by mixing 89.6 wt % of the polyester resin dispersion prepared in Preparation Example 2, 5.20 wt % of the pigment dispersion prepared in Preparation Example 3, and 5.20 wt % of the wax dispersion prepared in Preparation Example4. The above contents were based on solid contents. At this time, pure water was added to control a total solid content concentration to be 13 wt %. A temperature of the reactor was increased to 25° C., and mixing was performed by stirring at 120 rpm. 5.18 wt % (NaCl solid content weight based on the total solid content) of a 4.5 wt % NaCl aqueous solution was introduced as a agglomerating agent, and a homogenization process was performed with a homogenizer (IKA, T-50) while stirring at 140 rpm. Thereafter, the temperature of the reactor was increased to 50° C., and aggregation continued before the D50(v) became in a range of about 6.45 μm to about 6.50 μm. Then, 3.63 wt % (sodium hydroxide solid content based on the total solid content) of a 1N sodium hydroxide aqueous solution was introduced into the reactor to stop the growth of the particles and the stirring rate was decreased to 80 rpm. Then, the temperature of the reactor was increased to 80° C. to fuse the toner particles. The fusing continued before circularity reached 0.970. The temperature of the reactor was decreased to 40° C. and the toner was separated by using a filtration device (name of the device: filter press). Then, the separated toner was cleaned with a 1N nitric acid aqueous solution and again cleaned with distilled water to entirely remove the surfactant or the like. Thereafter, the toner particles after completion of the washing were dried at 40° C. for 5 hours in a fluidized bed dryer to obtain dried toner particles.

### EXAMPLE 2

A toner was prepared in the same manner as Example 1, except that the wax dispersion (2) was used instead of the wax dispersion (1).

### EXAMPLE 3

A toner was prepared in the same manner as Example 1, except that the wax dispersion (3) was used instead of the wax dispersion (1).

### COMPARATIVE EXAMPLE 1

A toner was prepared in the same manner as Example 1, except that silica was not added during the preparation of the wax dispersion.

### COMPARATIVE EXAMPLE 2

A toner was prepared in the same manner as Example 1, except that silica was added in an amount of 0.5 wt % during the preparation of the polyester resin dispersion, instead of the preparation of the wax dispersion.

### COMPARATIVE EXAMPLE 3

A toner was prepared in the same manner as Example 1, except that 1.00 wt % of NaClO was added in the homogenizing of the aggregation process, instead of adding silica in the wax dispersion.

Charge Quantity and Initial Charge Speed Measurements

A charge quantity was measured by using a Vertex Charge Analyzer 150 (Vertex Image Products, Yukon, Pa.) as a blow-off powder charge quantity measuring device.

In a blow-off method, a mixture of powder and carriers were put into a cylindrical container having screens installed at both ends. The powder and the carriers were separated from each other by blowing high-pressure gas through one of the ends, and then only the powder was blown off from meshes of the screen. At this time, a charge quantity, which is equivalent to a charge quantity carried by the powder to the outside of the cylindrical container and having an opposite polarity, remained in the carriers. Also, the entire electric flux generated by the charge quantity gathered in a condenser within a Faraday cage, and thus, the condenser was charged to such an extent. The electrical charge (Q) of the powder was calculated using the following equation by measuring a potential at both ends of the condenser.

Q=CV,

where C denotes capacity of the condenser, V denotes a voltage at both ends of the condenser, and Q denotes the electrical charge of the powder.

A charge speed was measured by dividing electrical charge generated between carriers and toner particles while mixing the carriers and the toner particles by the time taken to mix the carriers and the toner particles. An initial charge speed denotes a speed in which an electrical charge is formed on a toner. In an embodiment of the present invention, the initial charge speed was calculated by the electrical charge measured after 1 minute had passed after mixing the carriers and the toner.

TVOC

A gas chromatograph-mass spectrometer (Inlet: Gerstel TDS-2, GC: HP GC5890, Detector: HP MSD5972) equipped with a thermo desorption system (TDS) capable of collecting a volatile component of a solid sample was used in order to measure TVOC of a solid toner. At this time, for a pretreatment of the sample, 10 mg of the toner was prepared to be disposed at the center of a glass tube blocked with glass wool and installed in the TDS. At this time, the TDS was heated from about 40° C. to about 200° C. at a rate of 60° C./minute, and measurement conditions of gas chromatography-mass spectrometry (GC-MS) were the same as those of headspace GC-MS.

Odor Test

20 test participants were randomly selected, and printing was performed in confined space using the toners prepared in Examples 1 to 3 and Comparative Examples 1 to 3.

First, the prepared toners were respectively charged into Samsung CLP-510 printer cartridges, and 1,000 sheets of A4 paper having a letter image with 5% of coverage were printed. Then, statistics on subjective odor according to the location of printing and printing paper were obtained.

Results of the panel tests were evaluated as below.

1: very unpleasant

2: unpleasant

3: not unpleasant or fragrant

TABLE 1

| | | | | Comparative | Comparative | Comparative |
|---|---|---|---|---|---|---|
| | Example 1 | Example 2 | Example 3 | Example 1 | Example 2 | Example 3 |
| Silica content | 0.5 | 2.0 | 2.5 | 0 | 1.0 (in resin | NaClO |
| (wt %) | | | | | dispersion) | (homogenizing) |
| TVOC | 251.5 | 235.7 | 249.8 | 682.4 | Unable to | 307.5 |
| Panel test results | 3 | 2 | 3 | 1 | prepare resin | 3 |
| Charge quantity | 30.2 | 31.1 | 30.2 | 28.5 | dispersion | 15.0 |
| (−μC/g) | | | | | | |
| Initial charge speed | 15.4 | 15.2 | 14.6 | 14.8 | | 6.2 |
| (−μC/min) | | | | | | |

According to the above table, it may be understood that the preparation method according to an embodiment of the present invention may remove unpleasant odor without significantly affecting the charge quantity and initial charge speed of the toner.

While the present invention has been particularly shown and described with reference to exemplary embodiments thereof, it will be understood by those of ordinary skill in the art that various changes in form and details may be made therein without departing from the spirit and scope of the present invention as defined by the following claims. Hence, the protective scope of the present invention shall be determined by the accompanying claims.

1. A method of preparing a toner, the method comprising:
preparing a polyester resin dispersion by adding a polyester resin and an organic solvent to a polar solvent containing a surfactant and a dispersion stabilizer under stirring, and then heating;
mixing a colorant dispersion and a wax dispersion with the polyester resin dispersion to produce a mixed solution;
homogenizing the mixed solution by adding a agglomerating agent to produce a homogenized mixture;
aggregating the homogenized mixture; and
fusing aggregated toner particles,
wherein the wax dispersion is prepared by dispersing a wax and silica in a dispersion medium.

2. The method of claim 1, wherein an average particle size of the silica is in a range of about 5 nm to about 50 nm.

3. The method of claim 1, wherein an amount of the silica added is in a range of about 0.5 wt % to about 2.0 wt % in the wax dispersion.

4. The method of claim 1, wherein the organic solvent is at least one selected from the group consisting of methyl acetate, ethyl acetate, isopropyl acetate, methyl ethyl ketone, dimethyl ether, diethyl ether, 1,1-dichloroethane, 1,2-dichloroethane, dichloromethane, and chloroform.

5. The method of claim 1, wherein the polyester resin has an acid value ranging from about 5 mg KOH/g to about 50 mg KOH/g, a weight-average molecular weight ranging from about 5,000 to about 50,000, and a glass transition temperature ranging from about 40° C. to about 80° C.

6. The method of claim 1, wherein the polyester resin does not comprise a sulfonic acid group.

7. The method of claim 1, wherein the polar solvent is water.

8. The method of claim 1, wherein an amount of the organic solvent is in a range of about 15 parts by weight to about 200 parts by weight based on 100 parts by weight of the polyester resin.

9. The method of claim 1, wherein an amount of the surfactant is in a range of about 1 part by weight to about 4 parts by weight based on 100 parts by weight of the polyester resin.

10. The method of claim 1, wherein an amount of the dispersion stabilizer is in a range of about 2 equivalent weights to about 3 equivalent weights based on an acid value of the polyester resin.

11. The method of claim 1, wherein an amount of the polar solvent is in a range of about 150 parts by weight to about 500 parts by weight based on 100 parts by weight of the polyester resin.

12. The method of claim 1, further comprising washing and drying the toner particles after the fusing.
